(19) United States
(12) Patent Application Publication
(10) Pub. No.: US 2017/0183513 A1
(43) Pub. Date: Jun. 29, 2017

(54) COMPOSITIONS FOR REPAIRING DEFECTS IN SURFACE COVERINGS

(71) Applicant: ARMSTRONG WORLD INDUSTRIES, INC., Lancaster, PA (US)

(72) Inventors: GARY A. SIGEL, Columbia, PA (US); BURTON L. WILSON, Pine Knot, KY (US)

(21) Appl. No.: 14/980,313

(22) Filed: Dec. 28, 2015

(51) Int. Cl. C09D 5/34; C08J 7/04; B27N 7/00; C09D 151/08

(52) U.S. Cl. CPC C09D 5/34; C09D 151/08; C08J 7/047; B27N 7/005; C08J 2397/02; C08J 2451/08

(57) ABSTRACT

Described herein are putty compositions comprising: an initiator component comprising a thermal initiator and a photo initiator; an acrylate-functional resin; and a filler composition comprising: calcium carbonate particles; and glidant particles; wherein the calcium carbonate particles and the glidant particles are present in a weight ratio ranging from about 4:1 to about 1:1.

### FIELD OF THE DISCLOSURE

The present disclosure relates to a putty composition and wood substrates having surface defects treated with the putty composition—the putty composition having, inter alia, enhanced troughability and final aesthetic characteristics.

### BACKGROUND

Currently, defects in cellulosic substrates are repaired by manually filling the defect with a water-based curable composition. The present invention provides a composition and method for rapidly curing wood putty utilizing a combination of UV radical polymerization and thermal initiators. Previous methods require thiol-ene type chemistry that leads to noticeable odors and requires significant energy and time for full cure. In applications using water-based putty, the composition is allowed to air dry over a period of six to twenty-four hours that now removes goods in progress from being completed on-line. This now creates costly inventory and more labor required to remove puttied wood from line, stack down, and then when dry, place back onto line for completion of process. The use of water-based putty compositions also results inconsistent properties due to changes in environment, e.g. temperature and humidity that leads to defects when curing over the extended period of time. Slumping of the putty or excess shrinkage can occur when drying.

Thus, there remains a need for compositions suitable for use in an instant cure putty composition that can be used on wood products to allow for continuous flow through the process without interruption. Embodiments of the present invention are directed to meeting these needs.

### SUMMARY

In some embodiments, the present invention provides a composite panel comprising a first major surface opposite a second major surface, the composite panel further comprising: a cellulosic substrate comprising a top surface opposite a bottom surface, the top surface forming a part of the first major surface, the cellulosic substrate comprising at least one defect that forms a depression in the top surface of the cellulosic substrate; a cured polymeric composition formed from a putty composition comprising: an acrylate-functional resin; a filler composition comprising: calcium carbonate particles; and glidant particles selected from talc, magnesium stearate, silicon dioxide, starch, and a combination of two or more thereof; wherein the calcium carbonate particles and the glidant particles are present in a weight ratio ranging from about 4:1 to about 1:1; wherein the cured polymeric composition occupies at least a portion of the depression.

Other embodiments of the present invention include a method of repairing a cellulosic substrate comprising: heating a cellulosic substrate having at least one defect that forms a depression in a top surface of the cellulosic substrate to a temperature of greater than about 35° C.; applying a putty composition to the depression, the putty composition comprising: an acrylate-functional resin; a filler composition comprising: calcium carbonate particles; and glidant particles selected from talc, magnesium stearate, silicon dioxide, starch, and a combination of two or more thereof; wherein the calcium carbonate particles and the glidant particles are present in a weight ratio ranging from about 4:1 to about 1:1; and exposing the cellulosic substrate to a radiation source.

Other embodiments of the present invention include a putty composition comprising: an initiator component comprising a thermal initiator and a photo initiator; an acrylate-functional resin; and a filler composition comprising: calcium carbonate particles; and glidant particles; wherein the calcium carbonate particles and the glidant particles are present in a weight ratio ranging from about 4:1 to about 1:1.

### BRIEF DESCRIPTION OF THE DRAWINGS

The present invention will become more fully understood from the detailed description and the accompanying drawings, wherein:

FIG. 1 is a perspective view of a composite panel containing surface defects that have been treated according to the present invention;

FIG. 2 is a cross-sectional view of the cellulosic substrate taken along line II-II in FIG. 1;

FIG. 3 is a cross-sectional view of the composite panel taken along line II-II in FIG. 1.

### DETAILED DESCRIPTION

The following description of the preferred embodiment(s) is merely exemplary in nature and is in no way intended to limit the invention, its application, or uses.

As used throughout, ranges are used as shorthand for describing each and every value that is within the range. Any value within the range can be selected as the terminus of the range. In addition, all references cited herein are hereby incorporated by referenced in their entireties. In the event of a conflict in a definition in the present disclosure and that of a cited reference, the present disclosure controls.

Unless otherwise specified, all percentages and amounts expressed herein and elsewhere in the specification should be understood to refer to percentages by weight. The amounts given are based on the active weight of the material. According to the present invention, the term “about” means +/−5% of the referenced value. According to the present invention, the phrase “substantially free” means less than 1 wt. % based on the referenced amount.

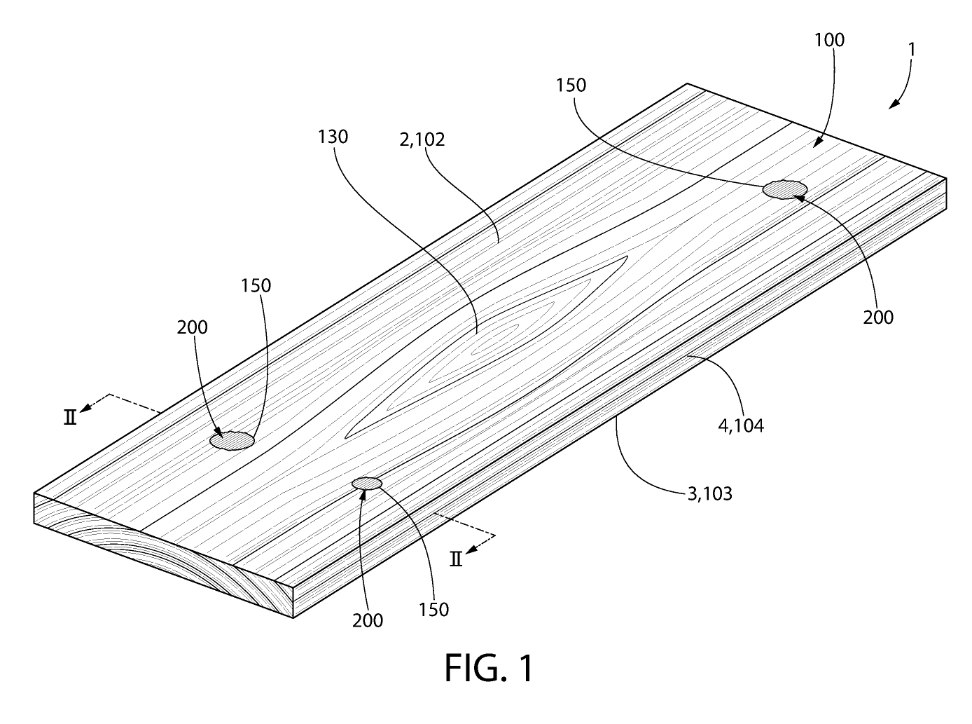

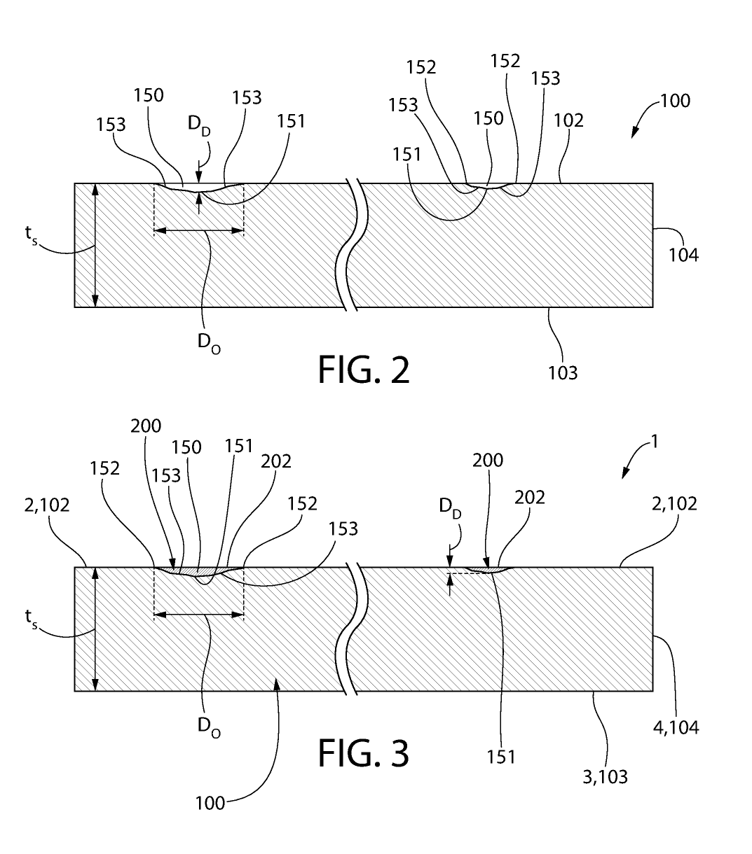

Referring to FIGS. 1-3 concurrently, the present invention provides a composite panel 1 comprising a cellulosic substrate 100 and cured polymeric composition 200. The composite panel 1 may comprise a first major surface 2 opposite a second major surface 3 and side major surfaces extending there-between 4. The cellulosic substrate 100 may be formed from wood and comprise a top surface 102 opposite a bottom surface 103 and side surfaces 104 extending there-between. The cellulosic substrate 100 may also comprise natural design features 130, such as a knot, burl, wood-grain, or the like. The cellulosic substrate 100 may have a thickness t_{S} ranging from about 180 mils to about 1000 mils as measured from the top surface 102 to the bottom surface 103—including all values and sub-ranges there-between. The composite panel 1 may also have a thickness that is substantially equal to the thickness t_{S} of the cellulosic substrate 100.

The cellulosic substrate 100 may comprise surface defects 150 that form depressions in the top surface 102 of the cellulosic substrate 100. Each depression 150 may comprise a floor 151 and side walls 153—with the floor 151 being the deepest point of the depression 150. The defects 150 may have a defect depth D_{D} as measured from the top surface 102 of the cellulosic substrate 100 to the floor 151 of the defect 150, where the defect depth D_{D} ranges from about 1 mil to about 100 mils—including all values and sub-ranges there-between. The side walls 153 may extend upward from the floor 151 and intersect with the top surface 102 to the cellulosic substrate 100 at an intersection point 152—wherein the side walls 153 may extend upward in a direction that is perpendicular or orthogonal to the top surface 102 of the cellulosic substrate 100. Each of the depressions 150 may have an opening distance D_{O} which is the distance measured between the intersection points 152 that exist on opposite side walls 153 for a single depression 150 in the cellulosic substrate 100. The opening distance D_{O} of may range from about 0.1 inches to about 2.0 inches—including all values and sub-ranges there-between.

According to the present invention, the defects 150 on the cellulosic substrate 100 may be repaired by filling the void created by each depressions 150 with a putty composition which is cured to form a cured polymeric composition 200, thereby producing the composite panel 1 of the present invention. As used herein, the term “putty” refers to a soft, sticky, dough-like material that hardens after it is cured.

As demonstrated in FIG. 3, the cured composition 200 may form a top repair surface 202 that faces the same direction as the top surface 102 of the cellulosic substrate. The top repair surface 202 of the cured polymeric composition 200 and the top surface 102 of the cellulosic substrate 100 may each form a part of the first major surface 2 of the composite panel. The top repair surface 202 may be substantially parallel to the top surface 102. The top repair surface 202 may be substantially co-planar with the top surface 102.

The putty composition of the present invention comprises a filler component (as discussed further herein) and a reactive composition. The filler component may be present in an amount ranging from about 25 wt. % to about 75 wt. % based on the total weight of the putty composition. The reactive component may be present in an amount ranging from about 20 wt. % to about 50 wt. % based on the total weight of the putty composition.

The reactive composition comprises one or more acrylate-functional resins. The acrylate-functional resin may comprise at least one acrylate-functional oligomer and, optionally, one or more acrylate-functional reactive diluents. According to the present invention, the terms “acrylate-functional” and “acrylate-functionality” refer to compounds having either acrylate and/or methacrylate functionality. Additionally, the terms “(meth)acrylate” and “(meth)acrylic acid” refer to compounds that may either be acrylate-functional or methacrylate-functional.

The acrylate-functional oligomer may be a linear or branched compound having an acrylate-functionality ranging from about 2 to 9—including all values and sub-ranges there-between. The acrylate-functional oligomer may each be selected from an epoxy-based acrylate oligomer, a polyester-based acrylate oligomer, a urethane-based acrylate oligomer, or a combination thereof.

The epoxy-based acrylate oligomer may be prepared by reacting epichlorohydrin with bisphenol A to form diglycidyl ethers of bisphenol, followed by the reaction of the diglycidyl ether of bisphenol product with acrylic acid and/or (meth)acrylic acid. The epoxy acrylate oligomer may be an aliphatic epoxy acrylate oligomer or an aromatic epoxy acrylate oligomer. The backbone of an aromatic epoxy acrylate oligomer may comprise an epoxy compound that includes one to three 1,2-epoxy groups per molecule, and preferably, from about two to about two and one half (2.5) 1,2-epoxy groups per molecule. A non-limiting example of the epoxy acrylate oligomer may be a glycidyl ether of a polyhydric phenol and polyhydric alcohol having an epoxide equivalent weight of from about 100 to about 500. The polyhydric phenol may be bisphenol-A, bisphenol-F, or a combination thereof.

The epoxy-based acrylate resin may comprise an oligomer of diglycidyl ether of tetrabromobisphenol A, epoxy novolacs based on phenol-formaldehyde condensates, epoxy novolacs based on phenol-cresol condensates, epoxy novolacs based on phenol-dicyclopentadiene condensates, diglycidyl ether of hydrogenated bisphenol A, digylcidyl ether of resorcinol, tetraglycidyl ether of sorbitol, and tetra glycidyl ether of methylene dianiline, as well as mixtures of two or more thereof.

Non-limiting examples of the epoxy acrylate oligomer is CN-120 (bisphenol based), CN-132 (diacrylate low viscosity oligomer) or CN-133 (triacrylate), available from Sartomer.

The polyester acrylate oligomer may be the reaction product of polyester polyol and an carboxylic acid functional acrylate compound such as (meth)acrylic acid, (meth)acrylic acid, or a combination thereof—at a OH:COOH ratio of about 1:1. The polyester polyol may have a hydroxyl functionality ranging from 2 to 9—including all values and sub-ranges there-between.

The polyester polyol may be the reaction product of a hydroxyl-functional compound and a carboxylic acid functional compound. The hydroxyl-functional compound is present in a stoichiometric excess to the carboxylic-acid compound. The hydroxyl-functional compound may be a polyol, such a diol or a tri-functional or higher polyol (e.g. triol, tetrol, etc.). The polyol may be aromatic, cycloaliphatic, aliphatic, or a combination thereof. The carboxylic acid-functional compound may be a dicarboxylic acid, a polycarboxylic acid, or a combination thereof. The dicarboxylic acid and polycarboxylic acid may each be aliphatic, cycloaliphatic, aromatic, or a combination thereof.

The diol may be an alkylene glycols, such as ethylene glycol, propylene glycol, diethylene glycol, dipropylene glycol, triethylene glycol, tripropylene glycol, hexylene glycol, polyethylene glycol, polypropylene glycol and neopentyl glycol; hydrogenated bisphenol A; cyclohexanediol; propanediol including 1,2-propanediol, 1,3-propanediol, butyl ethyl propanediol, 2-methyl-1,3-propanediol, and 2-ethyl-2-butyl-1,3-propanediol; butanediol including 1,4-butanediol, 1,3-butanediol, and 2-ethyl-1,4-butanediol; pentanediol including trimethyl pentanediol and 2-methylpentanediol; cyclohexanedimethanol; hexanediol including 1,6-hexanediol; caprolactonediol (for example, the reaction product of epsilon-caprolactone and ethylene glycol); hydroxy-alkylated bisphenol; polyether glycols, for example, poly(oxytetramethylene) glycol. In some embodiments, the tri-functional or higher polyol may be selected from trimethylol propane, pentaerythritol, di-pentaerythritol, trimethylol ethane, trimethylol butane, dimethylol cyclohexane, glycerol and the like.

The dicarboxylic acid may be selected from adipic acid, azelaic acid, sebacic acid, succinic acid, glutaric acid, decanoic diacid, dodecanoic diacid, phthalic acid, isophthalic acid, 5-tert-butylisophthalic acid, tetrahydrophthalic acid, terephthalic acid, hexahydrophthalic acid, methylhexahydrophthalic acid, dimethyl terephthalate, 2,5-furandicarboxylic acid, 2,3-furandicarboxylic acid, 2,4-furandicarboxylic acid, 3,4-furandicarboxylic acid, 2,3,5-furantricarboxylic acid, 2,3,4,5-furantetracarboxylic acid, cyclohexane dicarboxylic acid, chlorendic anhydride, 1,3-cyclohexane dicarboxylic acid, 1,4-cyclohexane dicarboxylic acid, and anhydrides thereof, and mixtures thereof. In some embodiments the polycarboxylic acid may be selected from trimellitic acid and anhydrides thereof.

In some embodiments, the polyester polyol comprises an aromatic polyester polyol that has an acid number of less than about 15, preferably less than about 5, comprising the reaction product of an equivalent excess of one or more polyols of equivalent weight less than 150 with at least one aromatic polycarboxylic acid. If the polycarboxylic acid is a phthalic acid derivative the result is a phthalate polyester polyol. Preferably at least 50 equivalent percent of the polycarboxylic acid is isophthalic acid, phthalic acid, terephthalic acid, phthalic anhydride, or dimethyl terephthalate.

Commercially available polyester acrylate oligomer include polyester-acrylate resins such as: Craynor® UVP-215, Craynor® UVP-220 (both ex Cray Valley), Genomer® 3302, Genomer® 3316 (both ex Rahn), Sartomer CN2261, CN9005, Laromer® PE 44F, Laromer PE 56F, Laromer 8992, Laromer 8800 (ex BASF), Ebecryl® 800, Ebecryl® 810, Viaktin® 5979, Viaktin® VTE 5969, and Viaktin® 6164 (100%).

The urethane acrylate oligomer may have an average acrylate functionality ranging from about 2 to about 6—including all values and sub-ranges there-between. In a preferred embodiment, the urethane acrylate oligomer may have an average acrylate functionality ranging from about 2 to about 4—including all values and sub-ranges there-between.

The urethane acrylate oligomer may be the reaction product of one or more high molecular weight polyol, polyisocyanate, and a hydroxyl-functional acrylate. The urethane acrylate oligomer may be produced by reacting the polyisocyanate and the hydroxyl-functional compounds at an NCO:OH ratio ranging from about 0.8:1 to about 1.2:1—preferably at about 1:1.

The high molecular weight polyol may have a hydroxyl functionality ranging from about 2 to about 4. Non-limiting examples of high molecular weight polyol include polyester polyol, polyether polyol, polyolefin polyol, and polycarbonate polyol having an average hydroxyl functionality ranging from about 2 to about 4. The polyester polyol used to create the urethane acrylate oligomer may be the same as the polyester polyol used to form the polyester acrylate oligomer.

The polyisocyanate may have an isocyanate-functionality ranging from about 2 to about 4. Non-limiting examples of polyisocyanate include aliphatic polyisocyanate, cycloaliphatic polyisocyanate, and/or aromatic polyisocyanate—such as 1,4-tetramethylene diisocyanate, 1,6-hexamethylene diisocyanate (HDI), 1,4-cyclohexyl diisocyanate and isophorone diisocyanate, 4,4′ diphenyl-methane diisocyanate and toluene diisocyanates. Polyisocyanate having an isocyanate functionality of 3 or 4 may include triisocyanates, biurets, allophanates, and isocyanurates of 1,6-hexamethylene-diisocyanate and isophorone diisocyanate may be used. The preferred polyisocyanates may include trimers of 1,6-hexamethylene diisocyanate, which is commercially available as Desmodus N from Bayer Corporation.

The hydroxyl-functional acrylate may have a hydroxyl functionality from about 1 to about 2 and an acrylate functionality from about 1 to about 3. Non-limiting examples of hydroxyl functional acrylate include the reaction product of acrylic acid and/or (meth)acrylic acid and a low molecular weight diol or polyol. In some embodiments, the low molecular weight diol is selected from monoethylene glycol, 1.2- and 1,3-propylene glycol, 1,4- and 2,3-butylene glycol, 1,5-pentanediol, 1,6-hexanediol, 1,8-octanediol, decanediol, dodecanediol, neopentylglycol, cyclohexa ediol and mixtures thereof. In some embodiments, the polyol is selected from pentaerythritol, neopentylglycol, dicidol, trimethylolpropane, and mixtures thereof. In some embodiments, the diol and polyol may contain alkyl branching or hydroxylalkyl branching such as trimethylolpropane. In other embodiments, the polyol comprises a mixture of a polyol having a hydroxyl functionality of three or greater and a diol. In other embodiments, the polyol may have a chain length of from C₂ to C₄ or from C₂ to C₃, between the hydroxyl groups.

The reactive composition may comprise up to 40 wt. % of an acrylate-functional reactive diluent. Reactive diluents are compounds that serve a dual purpose: such compounds are not only capable of covalently bonding with acrylate-functional oligomer but are also capable of reducing the viscosity of the overall putty composition. The reactive diluents may have number average molecular weights of about 226 to about 2000—including all values and sub-ranges there-between. The reactive diluent may have an acrylate functionality ranging from 1 to 5—including all values and sub-ranges there-between.

In some embodiments, the acrylate-functional oligomer of the reactive component may comprise a blend of epoxy based oligomer and urethane based oligomer in a weight ratio ranging from about 1:1 to about 1:3. In some embodiments, the acrylate-functional oligomer reactive may be substantially all polyester based oligomer.

Suitable reactive diluents include, but are not limited to, (meth)acrylic acid, isodecyl (meth)acrylate, N-vinyl formamide, isobornyl (meth)acrylate, tetraethylene glycol (meth)acrylate, tripropylene glycol (meth)acrylate, hexanediol di(meth)acrylate, ethoxylate bisphenol-A di(meth)acrylate, ethoxylated neopentyl glycol di(meth)acrylate, propoxylated neopentyl glycol di(meth)acrylate, ethoxylated tripropylene glycol di(meth)acrylate, glyceryl propoxylated tri(meth)acrylate, tris (2-hydroxy ethyl) isocyanurate tri(meth)acrylate, pentaerythritol tri(meth)acrylate, pentaerythritol tetra(meth)acrylate, dimethylol propane tri(meth)acrylate dipentaerythritol monohydroxypenta(meth)acrylate, and trimethylol propane tri(meth)acrylate and its ethoxylated and propoxylated analogues of the skeletal structures in Formula 3:

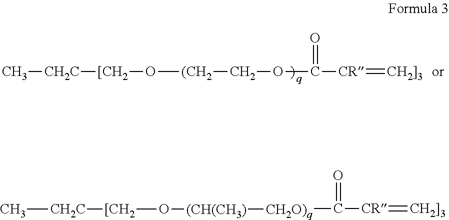

Where R″=H, or CH₃, and q=0, 1, 2, 3, 4, 5, 6, 7, 8, 9 or 10.

The preferred (meth)acrylate reactive diluents are the multifunctional acrylates with number average molecular weights of about 226 to about 2000. Examples of such are tetraethylene glycol diacrylate with a molecular weight of about 302, ethoxylated bisphenol-A diacrylate with a number average molecular weight of about 776 (SR602 from Sartomer Company), trihydroxyethyl isocyanurate triacrylate with molecular weight of about 423 (SR368 from Sartomer), trimethylol propane triacrylate with a number average molecular weight of about 296 (SR351 from Sartomer), and ethoxylated trimethylol propane triacrylates with number average molecular weights from about 400 to about 2000 (SR454, SR499, SR502, SR9035, and SR 415 from Sartomer Company and Photomer 4155 and Photomer 4158 from Henkel Corporation). Tetra-functional reactive diluent may comprise pentaerythritol tetraacrylate. Penta-functional reactive diluent may comprise dipentaerythritol pentaacrylate.

Additionally, when the reactive composition comprises an epoxy-based oligomer, the reactive composition may further comprise an epoxy flexibilizer. Non-limiting examples of flexibilizer includes rubber-modified bisphenol A epoxies, epoxidized castor oil based epoxies, and epoxies which are modified with dimerized fatty acids, as well as mixtures thereof.

The putty composition further comprises an initiator component comprising a mixture of thermal initiator and a photo initiator. The mixture of thermal initiator and photo initiator provides a dual cure mechanism to the putty composition (e.g., curing by heat and UV radiation) that ensures fast and proper through-cure of the putty composition to form the cured polymeric composition 200. The term “through-cure” indicates that the substantially all of the putty composition that has been applied to one or more defects 150 in the cellulosic substrate 100 has been chemically cured by cross-linking of the free acrylate groups present on the first acrylate oligomer and the second acrylate oligomer (and, optionally, the third acrylate oligomer), thereby forming the cured polymeric composition 200.

The dual cure mechanism of the present invention results in through-cure for putty compositions applied to depressions having a defect depths D_{D} as high as about 100 mils. Unlike the soft, sticky, dough-like putty composition, the cured polymeric composition 200 is a rigid, non-tacky material at room temperature that has a hardness of at least the surrounding cellulosic substrate 100. Therefore, the dual cure mechanism provides fast and efficient formation of the cured polymeric composition 200 throughout the substantially the entire defect 150 (up to defect depths D_{D} of 100 mils), which in-turn allows for fast and efficient post-processing of the composite panel 1 (e.g., milling, surface sanding, abrading, etc.) as the cured polymeric composition 200 can quickly be post-treated in the same way that cellulosic substrate 100 without special concern to a partially cured putty composition.

Depending on the type of reactive composition selected, the type and amount of initiator and solvent may vary. The amount of photoinitiator should be sufficient to achieve acceptable curing of the composition when it is irradiated but not so large that it affects the properties of the cured composition in a negative way.

The photo initiator may be present in an amount ranging from about 0.1 wt. % to about 1.0 wt. % based on the total weight of the putty composition—including all values and sub-ranges there-between. In a preferred embodiment, the photo initiator may be present in an amount of about 0.3 wt. % to about 0.8 wt. % based on the total weight of the putty composition—including all values and sub-ranges there-between.

The photo initiator may be water soluble and include benzophenone-type initiators, phosphine oxides, acetophenone derivatives, and cationic photo initiators such as triaryl sulfonium salts and aryliodonium salts. The photo initiator may be selected from benzophenone; 4-methylbenzophenone; benzyl dimethyl ketal; diethoxy acetophenone; benzoin ethers; thioxanthones; 1-hydroxycyclohexyl phenyl ketone; 2-hydroxy-2-methyl-1-phenol-propane-1-one; 4-(2-hydroxyethoxy)phenyl-(2-hydroxy-2-methylpropyl) ketone; 2,4,6-trimethylbenzoyl diphenylphosphine oxide; bis (2,6-dimethoxybenzoyl)-2,4,4-trimethylpentyl phosphine oxide; ethyl-2,4,6-Trimethylbenzoylphenylphosphinate; 2,2-dimethoxy-2-phenyl acetophenone; 2,2-dimethoxy-1,2-diphenylethan-1-one; bis(2,4,6-trimethylbenzoyl)-phenyl-phosphineoxide; 2-benzyl-2-N,N-dimethylamino-1-(4-morpholinophenyl)-1-butanone; and 2-methyl-1-[4-(methylthio)phenyl]-2-morpholino propan-1-one, and a combination of two or more thereof.

The photo initiator may be used alone or in combination with other photo initiators. The putty composition may further comprise photosensitizers. Non-limiting examples of photosensitizer include isopropyl thioxanthone, chlorothioxanthone, quinones such as camphorquinone; 4,4′-bis(dimethylamino)benzophenone; 4,4′-bisdiethylamino benzophenone ethyl ketone; thioxanthone, benzanthrone, triphenyl acetophenone and fluorenone, dimethylethanolamine, methyldiethanolamine, triethanolamine, N,N-dimethyl-para-toluidine, N-[2-hydroxyethyl]-N-methyl-para-toluidine, octyl-para-N,N-dimethylamino benzoate, and ethyl-para-N,N-dimethylamino benzoate.

The thermal initiator may be present in an amount ranging from about 0.1 wt. % to about 1.0 wt. % based on the total weight of the putty composition—including all values and sub-ranges there-between. In a preferred embodiment, the thermal initiator may be present in an amount of about 0.3 wt. % to about 0.8 wt. % based on the total weight of the putty composition—including all values and sub-ranges there-between. The thermal initiator may comprise a free radical initiator that generates radicals upon exposure to heat rather than light. The thermal initiator may be selected from a peroxide compound, an azo compound, and a combination thereof. Non-limiting examples of azo compounds include 2,2′-azobis-(2,4-dimethylvaleronitrile), azobisisobutyronitrile, azobisisoheptanonitrile, azobisisopentanonitrile, and 2,2′-azobis-(2-methylbutyronitrile); 1,1′-azobis-(1-cycloltexanecarbonitrile).

Non-limiting examples of peroxide initiators include diacyl peroxides, such as 2-4-diclorobenzyl peroxide, diisononanoyl peroxide, decanoyl peroxide, lauroyl peroxide, succinic acid peroxide, acetyl peroxide, benzoyl peroxide, and diisobutyryl peroxide, acetyl alkylsulfonyl peroxides, such as acetyl cyclohexylsulfonyl peroxide, dialkyl peroxydicarbonates, such as di(n-propyl) peroxydicarbonate, di(sec-butyl) peroxydicarbonate, di(2-ethylhexyl) peroxydicarbonate, t-butyl-peroxymaleic acid, diisopropyl peroxydicarbonate, and dicyclohexyl peroxydicarbonate, peroxy esters such as alpha-cumyl peroxyneodecanoate, alpha-cumyl peroxypivalate, t-amyl peroxyneodecanoate, t-butyl peroxyneodecanoate, t-amyl peroxypivalate, t-butyl peroxypivalate, 2,5-dimethyl-2,5-di(2-ethylhexanoylperoxy)hexane, t-amylperoxy-2-ethyl hexanoate, t-butyl peroxy-2-ethyl hexanoate, t-butyl peroxyisobutyrate, t-butyl peroxyacetate, t-butyl peroxybenzoate, di-t-butyl diperoxy azelate, and di-t-butyl diperoxy phthalate, dicumyl peroxide, 2,5-dimethyl-2,5-di(t-butylperoxy)hexane, t-butyl cumyl peroxide, di-t-butyl peroxide, and 2,5-dimethyl,2,5-di(t-butylperoxy)hexyne-3, a hydroperoxide, such as 2,5-dihydroperoxy-2,5-dimethyl hexane, cumene hydroperoxide, t-butyl hydroperoxide and t-amyl hydroperoxide, n-butyl-4,4-bis-(t-butylperoxy)valerate, 1,1-di(t-butylperoxy)-3,3,5-trimethyl cyclohexane, 1,1′-di-t-amyl-peroxy cyclohexane, 2,2-di(t-butylperoxy) butane, ethyl-3,3-di(t-butylperoxy)butyrate, t-butyl peroctoate, and 1,1-di(t-butylperoxy)cyclohexane.

The putty composition may further comprise free radical inhibitor. Non-limiting examples of free radical inhibitor include N-nitroso-N-phenylhydroxylamine, ammonium salt, tris[N-nitroso-N-phenylhydroxylamine, aluminum salt, p-methoxyphenol MEHQ, hydroquinone and substituted hydroquinones, pyrogallol, phenothiazine, and 4-ethyl catechol, and combinations thereof.

The initiator component may further comprise a solvent. The solvent may be present in the initiator component in an amount ranging from about 0.5 wt. % to about 4 wt. % based on the total weight of the putty composition—including all values and sub-ranges there=between. In some embodiments, the ratio of the solvent to the thermal initiator is from about 4:1 to about 1:1. Non-limiting examples of solvent include an aromatic solvent, such as toluene or benzene; and a non-aromatic solvent, such as acetone, chloroform, ethylacetate, or methyl methacrylate. In some embodiments, the solvent comprises acetone.

The putty composition of the present invention may be substantially free of thiol-functional compounds. According to some embodiments, the putty composition of the present invention may be entirely free of thiol-functional compounds (i.e. comprise 0 wt. % of thiol-functional compounds based on the total weight of the putty composition). The putty composition of the present invention ensures fast and proper through-cure of the putty composition to form the cured polymeric composition 200 even without the addition of thiol-functional compounds, such as tri-thiol.

The putty composition of the present invention may further comprise colorant, surfactant, or combinations thereof. The colorant may comprise a dye, a pigment, or a combination thereof. The colorant may be present in an amount ranging from about 0.5 wt. % to about 8 wt. % based on the total weight of the putty composition—including all values and sub-ranges there-between. The pigment may include particles that impart yellow, red, green, blue, black, and combinations thereof, to the putty composition. The surfactant may be present in an amount ranging from about 0.1 wt. % to about 1 wt. % based on the total weight of the putty composition—including all values and sub-ranges there-between.

The putty composition may further comprise filler. The filler may be present in an amount ranging from about 20 wt. % to about 70 wt. % based on the total weight of the putty composition—including all values and sub-ranges there-between. Non-limiting examples of filler include glass flit, flour, calcium carbonate, calcium sulfate dihydrate (Gypsum), calcium hydrate hemihydrate, barium sulfate, mica, ammonium chloride, ammonium bromide, boric acid, antimony trioxide, alumina (e.g. fumed alumina), clays such as kaolin, china clay, lithopone, zinc sulfide, zirconium oxide, barium oxide, calcium oxide or hydroxide, magnesium silicate (Talc), oxide or hydroxide, ceramic, hollow glass, hollow microspheres, resin microspheres, pearl essence, barites, diatomaceous earth, aluminum trihydrate, onyx flour, calcium silicate, mixed silicates, and the like. The hollow microspheres may be zinc hollow spheres.

In a preferred embodiment, the filler comprises a blend of two fillers—a first filler comprising particles of calcium carbonate and a second filler comprising a glidant. The first filler may have a particle size ranging from about 7 μm to about 15 μm—including all values and sub-ranges there-between. The second filler may have a particle size ranging from about 1 μm to about 100 μm (preferably between 1 um to 50 um and most preferred between 1 to 15 ums)—including all values and sub-ranges there-between.

Non-limiting examples of glidant include particles of talc, magnesium stearate, silicon dioxide, starch, and a combination of two or more thereof. The first filler and the second filler may be present in a weight ratio ranging from about 4:1 to about 1:1—including all ratios and sub-ranges there-between. In a preferred embodiments, the glidant may comprise talc and the ratio of the first filler to the second filler may ranges from about 3:1 to about 1:1—including all ratios and sub-ranges there-between.

In an alternative embodiment, the calcium carbonate may be replaced partially or entirely with hollow microspheres and the ratio of the first filler to the second filler ranges from about 1:1 to about 1:10—including all values and sub-ranges there-between.

The putty composition of the present invention may a viscosity ranging from about 100,000 cP to about 400,000 cP at about 25° C. —including all values and sub-ranges there-between. In some embodiments, the putty composition exhibits a viscosity of from about 150,000 cP to about 300,000 cP at about 25° C. —including all values and sub-ranges there-between. In some embodiments, the putty composition exhibits a viscosity of from about 175,000 cP to about 250,000 cP at about 25° C. —including all values and sub-ranges there-between. The viscosity described herein is measured on a Brookfield viscometer at 10 RPMs.

The putty composition may further comprise a viscosity modifying agent in an amount effective such that the putty composition exhibits the desired viscosity. Non-limiting examples of viscosity modifying agent comprises fumed silica and/or a dispersant. Putty compositions above 500,000 cP at about 25° C. are not suitable for this invention as ease of troughability is dramatically reduced that results in uncured putty pull out of defects in trough process. (putty rolls back up).

The putty composition may be formed by combining the filler and the reactive composition, the initiator component, solvent, and optionally, pigments, and surfactant. In some embodiments, the thermal initiator may be pre-dissolved in the solvent before being added to the other components of the putty composition.

The composite panel 1 may be formed by heating a cellulosic substrate 100 that a defect 150 on the top surface 102 to a temperature of greater than about 35° C. In some embodiments, the cellulosic substrate may be heated to a temperature of from about 37° C. to about 70° C. In other embodiments, the cellulosic substrate may be heated to a temperature of from about 57° C. to about 66° C. The bottom surface 103 of the cellulosic substrate 100 may face an upper surface of a conveyor belt or other work surface.

During one or more stages of the manufacturing process—including the curing stage, the cellulosic substrate 100 may be processed along a machine direction at a line speed of from about 10 feet/minute (fpm) to about 70 fpm—including all values and sub-ranges there-between. In some embodiments, the conveyor belt has a line speed of from about 20 fpm to about 60 fpm—including all values and sub-ranges there-between. In some embodiments, the conveyor belt has a line speed of from about 30 fpm to about 50 fpm—including all values and sub-ranges there-between. In some embodiments, the conveyor belt has a line speed of about 35 fpm. In some embodiments, the conveyor belt has a line speed of 33 fpm. The cellulosic substrate 100 may be processed along the machine direction using a conveyor belt.

The putty composition may be applied to the defect 150, and the cellulosic substrate 100. In the defect 150, the putty composition forms a putty top surface that faces substantially the same direction as the top surface 102 of the cellulosic substrate 100. The cellulosic substrate 100 may then be exposed to a radiation source and the putty composition cures to form the cured polymeric composition 200 within the cellulosic substrate 100, thereby forming the composite panel 1 of the present invention. The putty top surface may be exposed to atmospheric conditions during curing. Stated otherwise, the putty top surface is not covered by an external membrane or protective film/layer during exposure to the UV radiation during curing. Rather, the putty top surface of the putty composition and at least a portion of the top surface 102 of the cellulosic substrate 100 are exposed to the surrounding atmospheric conditions during curing. Thus the top putty surface forms the top repair surface 202 while exposed to atmospheric conditions and not under the protection of an external layer and/or membrane.

The cellulosic substrate 100 having the putty composition applied thereto can be cured by conveying the cellulosic substrate 100 along the machine direction wherein the radiation source is located above the cellulosic substrate 100 and conveyor belt, facing downward. As the cellulosic substrate 100 and putty composition applied there to pass underneath the radiation source, the putty composition is exposed to the UV radiation that is emitted from the radiation source.

The radiation source may comprise ultraviolet radiation. The radiation source may be a UV lamp that emits UV radiation having a peak irradiance ranging from about 350 mW/cm² to about 4000 mW/cm²—including all values and sub-ranges there-between and as measured by using an EIT Instruments pack or mapper in the UVA regime. In some embodiments, the radiation source may emit UV radiation having a peak irradiance ranging from about 350 mW/cm² to about 1,000 mW/cm²—including all values and sub-ranges there-between. The radiation source may be a mercury vapor UV lamp or an LED emitting radiation lamp, wherein the radiation that is emitted has a wavelength in the range of about 350 nm to about 400 nm—including all values and sub-ranges there-between. The LED may emit radiation at a wavelength ranging from 365 nm to 395 nm and have a LED peak irradiance as high as 20 W/cm² as measured by Nobel Probe.

Moving along the machine direction at the above referenced line speed, the putty composition applied to the cellulosic substrate 100 can be cured with UV radiation from the radiation source, wherein the UV radiation output required to cure the putty composition (including complete through cure) totals to an amount ranging from about 300 mJ/cm² to about 4000 mJ/cm²—including all values and sub-ranges there-between. Additionally, the putty composition may be cured with as little as a single pass under the radiation source. In other embodiments, the cellulosic substrate 100 having the putty composition applied thereto may be cured by passing underneath the radiation source with multiple passes—e.g., 2 to 10 passes—including all value and sub-ranges there-between. The composite panel 1 may then be cooled at a surface temperature ranging from about 54° C. to about 63° C. —including all temperatures and sub-ranges there-between.

In a preferred embodiment, the cellulosic substrate 100 having the putty composition applied thereto can be cured with a single pass under the radiation source, which provides for a continuous manufacturing process of flooring materials and products that further includes defect repair. Stated otherwise, using the putty composition of the present invention provides a useful way to repair surface defects 150 in cellulosic substrates 100 without having to temporarily separate the cellulosic substrate 100 from a continuous manufacturing process—e.g., stopping in-line flooring material manufacture so that a cellulosic board may be removed from the in-line production and relocated to a separate isolated repair process. Rather, defects 150 in cellulosic substrates 100 can be repaired along the overall continuous manufacturing process such that the defects can be repair immediately after the initial processing of the cellulosic board (e.g., board milling) and immediately before further processing steps (e.g., board sanding, additional cutting, surface staining and/or sealing) without the need to pause the overall manufacturing process for surface defect repair. With a single pass, the defects in the cellulosic substrate can be repaired along a conveyor otherwise intended to shaping, sanding, and/or staining the cellulosic substrate in an effort to create a flooring material.

The enhanced troughability and dual cure mechanism of the putty composition allows for faster manufacture of the overall composite panel 1 as the putty composition can be applied, troughed (i.e., physically manipulated into the depression 150), and fully cured to a total depth up to 100 mils within a quick and continuously process. The term “continuous process” means that the cellulosic substrate have surface defects can be identified, filled with the putty composition, and fully cured without need for the cellulosic board to be temporarily removed from the overall manufacturing process. Stated otherwise, using the putty composition of the present invention eliminates the need for temporary stoppage of manufacturing for a side-process to repair surface defects. Rather the putty composition of the present invention allows for continuous manufacture of flooring materials wherein the materials can be repaired concurrently with the otherwise main manufacturing steps (i.e., surface sanding, dimension cuttings, surface staining).

In non-limiting embodiments, a flooring panel may comprise the composite panel 1 of the present invention. The flooring panel may further comprise an underlayment applied to the second major surface 2 of the composite panel 1. The flooring panel may further comprise a wear layer applied to the first major surface 1 of the composite panel 1.

The invention will be described in greater detail by way of specific examples. The following examples are offered for illustrative purposes and are not intended to limit the invention in any manner.

### EXAMPLES

Described in Table 1 (below) are the compositions of four (4) exemplary putty compositions of the present invention (Ex. 1-Ex. 8), along with the compositions for two (2) comparative putty compositions (Comp. Ex. 1-Comp. Ex. 2).

The examples each contains an acrylate-functional resins, as described herein:

Resin A is a blend of 65 wt. % epoxy based acrylate with 35 wt. % urethane based acrylate.

Resin B is a blend of 64 wt. % of tetra-functional urethane acrylate and 36 wt. % of reactive diluent. The urethane acrylate being the reaction product of:
i. 51 wt. % of Polyester polyol having a hydroxyl number=185, acid number <0.5 and prepared from 20.0 equivalents of phthalate anhydride 23.8 equivalents of 1,6-hexanediol 6.0 equivalents of glycerine;
ii. 35 wt. % of isocyanurate of HDI (commercially available as Desmodur N3300 from Bayer); and
iii. 14 wt. % of hydroxyacrylate (commercially available from Union Carbide).

The reactive diluent of Resin B comprises a blend of 44 wt. % of trimethylol propane triacrylate (commercially available as SR351 from Sartomer); 28 wt. % of ethoxylated (degree=6) of trimethylol propane triacrylate (commercially available as SR499 from Sartomer); and 28 wt. % of ethoxylated (degree=9) of trimethylol propane triacrylate (commercially available as SR502 from Sartomer).

Resin C is a blend of about 60 wt. % to about 70 wt. % of di-functional polyester acrylate and about 30 wt. % to about 40 wt. % of reactive diluent. The polyester acrylate being the reaction product of acrylic acid and a polyester diol in a COOH—OH ratio of 1:1. The polyester diol being the reaction product of:
iv. 1.0 equivalent of trimellitic anhydride;
v. 2.0 equivalents of 1,6-hexanediol; and

The reactive diluent of Resin C comprising ethoxylated trimethylol propane triacrylate, having a degree of alkoxylation ranging from about 15 to about 20.

Resin D is a blend of 87 wt. % of polyester acrylate oligomer (commercially available as CN 2262 from Sartomer) and 14 wt. % of dipentaerythritol pentaacrylate (commercially available as SR399 from Sartomer).

### Examples 1-8

Each putty composition was prepared by mixing the resin, filler, initiator, and other auxiliary materials (e.g., pigment, dispersants, fumed silica) with mechanical agitation. Each example further included a cellulosic substrate that was subjected to a pre-heat step before application of the corresponding putty composition. The pre-heat step included passing the cellulosic substrate under UV lamps to achieve a board surface temperature (BST) of 37° C. to 55° C. prior to application of the putty compositions. Subsequently, each putty composition was applied to and filled defects on a cellulosic substrate by using either a plastic dropper or another dispensing device. The defects included knot holes having a depth of about 80 mil. Each treated cellulosic substrate was then passed under UV lamps—thereby initiating UV curing of the putty composition. The UV radiation of each example is set forth below in Table 1.

TABLE 1

| | | | | | | | | | Comp. | Comp. |
|---|---|---|---|---|---|---|---|---|---|---|
| | Ex. 1 | Ex. 2 | Ex. 3 | Ex. 4 | Ex. 5 | Ex. 6 | Ex. 7 | Ex. 8 | Ex. 1 | Ex. 2 |
| Feed Speed (fpm) | 33 | 33 | 33 | 33 | 66 | 66 | 66 | 66 | 33 | 33 |
| # Passes | 1 | 1 | 1 | 1 | 1 | 1 | 1 | 1 | 1 | 1 |
| Lamp Radiation | 3.6 | 3.6 | 3.6 | .396 | 396 | .396 | .396 | .396 | 3.6 | 3.6 |
| Output (W/cm²) | | | | | | | | | | |
| Lamp Radiation | 3.5 | 3.5 | 3.5 | .736 | .736 | .736 | .736 | .736 | 3.5 | 3.5 |
| Output (J/cm²) | | | | | | | | | | |
| Through Cure*** | Y | Y | Y | Y | Y | Y | Y | Y | Y | Y |
| Depth of Defect | 80 | 80 | 80 | 80 | 80 | 80 | 80 | 80 | 80 | 80 |
| | mils | mils | mils | mils | mils | mils | mils | mils | mils | mils |

***Absence of “through cure” is confirmed by the oozing of uncured putty from the sides of a defect after the defect is pressed.

The troughability and pin-hole performance of each example is set forth below in Table 79.

As set forth in Table 2, troughability was measured by the putty composition being able to be applied to a defect either by machine or by hand using a putty knife and the putty composition being present in the defect and exhibiting minimal self-rolling characteristics, whereby the putty composition retains a substantial degree of its shape or orientation as it exhibited immediately before application to the defect. Acceptable troughability allows for the putty composition to be properly applied to the defect with minimal amounts of effort while unacceptable troughability requires additional pressure and working in order to get the putty composition into the desired shape and orientation of the surface defect.

TABLE 2

| | | | | | | | | |
|---|---|---|---|---|---|---|---|---|
| | | | | | | | Comp. | Comp. |
| Ex. 1 | Ex. 2 | Ex. 3 | Ex. 4 | Ex. 5 | Ex. 6 | Ex. 7 | Ex. 1 | Ex. 2 |

Wt. %

| | | | | | | | | | |
|---|---|---|---|---|---|---|---|---|---|
| Resin A* | 36.3 | 39.6 | 38.7 | — | — | — | — | 31.4 | 57.3 |
| Resin B* | — | — | — | 40.8 | 46.4 | — | — | — | — |
| Resin C* | — | — | — | — | — | 36.9 | — | — | — |
| Resin D | — | — | — | — | — | — | 31.6 | — | — |
| CaCO₃ | 38.2 | 38.6 | 43.9 | 43.5 | 24.8 | 40.0 | 49.8 | 65.4 | — |
| Talc | 22.9 | 19.3 | 14.6 | 13.1 | 24.8 | 20.0 | 16.6 | — | 38.6 |
| Fumed Silica | 0.4 | — | 0.6 | 0.4 | 0.5 | 0.4 | 0.3 | 1.3 | 0.6 |
| Thermal Initiator | 0.4 | 0.5 | 0.5 | 0.6 | 0.7 | 0.5 | 0.3 | 0.4 | 0.7 |
| Photo Initiator | — | — | — | — | — | — | 0.6 | — | — |
| Dispersant** | 0.6 | 0.8 | 0.5 | 0.5 | 0.6 | 0.5 | 0.2 | 0.5 | 1.0 |
| Pigment | <0.1 | <0.1 | <0.1 | 0.3 | 0.3 | 0.2 | 0.1 | <0.1 | <0.1 |
| Acetone | 1.1 | 1.2 | 1.2 | 0.8 | 1.9 | 1.5 | 0.5 | 0.9 | 1.7 |
| Total | 100 | 100 | 100 | 100 | 100 | 100 | 100 | 100 | 100 |

Performance

| | | | | | | | | | |
|---|---|---|---|---|---|---|---|---|---|
| Troughable*** | Y | Y | Y | Y | Y | Y | Y | N | Y |
| Pin Holes**** | A | A | A | A | A | A | A | A | U |

*Ingredient contains photo initiator
**Phosphoric acid polyester
***Troughable: Yes (Y); No (N)
****Pin Holes: Acceptable (A); Unacceptable (U)

As demonstrated by Examples 1 to 7 in Table 2, the addition of a filler component comprising a calcium carbonate and a glidant in a weight ratio ranging from about 4:1 to about 1:1 not only provides a wood putty that is not only easily troughable (i.e., can be easily worked by hand or machine in preparation of application to a cellulosic substrate comprising surface defects), but surprisingly forms a cured composition that exhibits superior pin-hole performance—i.e., there are little-to-no pin holes in the cured composition. Such pin-hold performance is critical to defect repair in wood because the final appearance of the cured composition must closely resembles the surrounding cellulosic substrate—which is undermined by the presence of pin-holes

### Example 8

As shown in Comparative Example 2—the absence of CaCO3 particles may provide a troughable putty composition, however, the resulting cured composition exhibits inadequate pin hole performance (i.e., the appearance of too many pin holes to be used as a commercially acceptable building product—such as a flooring product). However, it has been surprisingly discovered that the addition of hollow microspheres—in as little as about 3 wt. %—can offset the inferior pin hold performance of the resulting cured composition—as demonstrated below in Table 3.

TABLE 3

| | |
|---|---|
| Ex. 8 | Comp. Ex. 2 |

Wt. %

| | | |
|---|---|---|
| Resin A* | 58.9 | 57.3 |
| CaCO₃ | — | — |
| Talc | 34.7 | 38.6 |
| Hollow Spheres | 3.1 | — |
| Fumed Silica | — | 0.6 |
| Initiator | 0.9 | 0.7 |
| Dispersant** | 0.2 | 1.0 |
| Pigment | 0.1 | <0.1 |
| Acetone | 2.1 | 1.7 |
| Total | 100 | 100 |

Performance

| | | |
|---|---|---|
| Troughable*** | Y | Y |
| Pin Holes**** | A | U |

*Ingredient contains photo initiator
**Phosphoric acid polyester
***Troughable: Yes (Y); No (N)
****Pin Holes: Acceptable (A); Unacceptable (U)

It is intended that any patents, patent applications or printed publications, including books, mentioned in this patent document be hereby incorporated by reference in their entirety.

As those skilled in the art will appreciate, numerous changes and modifications may be made to the embodiments described herein, without departing from the spirit of the invention. It is intended that all such variations fall within the scope of the invention.

1. A composite panel comprising a first major surface opposite a second major surface, the composite panel further comprising:
a cellulosic substrate comprising a top surface opposite a bottom surface, the top surface forming a part of the first major surface, the cellulosic substrate comprising at least one defect that forms a depression in the top surface of the cellulosic substrate;
a cured polymeric composition formed from a putty composition comprising:
an acrylate-functional resin;
a filler composition comprising:
calcium carbonate particles; and
glidant particles selected from talc, magnesium stearate, silicon dioxide, starch, and a combination of two or more thereof;
wherein the calcium carbonate particles and the glidant particles are present in a weight ratio ranging from about 4:1 to about 1:1;
wherein the cured polymeric composition occupies at least a portion of the depression.

2. The composite panel according to claim 1, wherein the putty composition further comprises a thermal initiator and a photo initiator

3. The composite panel according to claim 1, wherein the filler composition is present in an amount ranging from about 25 wt. % to about 75 wt. % based on the total weight of the putty composition.

4. The composite panel according to claim 1, wherein the putty composition has a viscosity ranging from about 100,000 cP to about 400,000 cP at about 25° C.

5. The composite panel according to claim 1, wherein the acrylate-functional resin comprising an oligomer selected from polyester acrylate oligomer, epoxy acrylate oligomer, urethane acrylate oligomer, and combinations thereof.

6. The composite panel according to claim 1, wherein the acrylate-functional resin comprises an acrylate functional reactive diluent having an acrylate-functionality ranging from 1 to 3.

7. The composite panel according to claim 2, wherein the thermal initiator that is present in an amount ranging from about 0.1 wt. % to about 0.8 wt. % based on the total weight of the putty composition.

8. The composite panel according to claim 2, wherein the photo initiator is present in an amount ranging from about 0.2 wt. % to about 0.9 wt. % based on the total weight of the putty composition.

9. The composite panel according to claim 1, wherein the cured polymeric composition is present in the depression such that the cured polymeric composition forms a part of the first major surface.

10. A method of repairing a cellulosic substrate comprising:
(a) providing a cellulosic substrate having at least one defect that forms a depression in a top surface of the cellulosic substrate;
(b) applying a putty composition to the depression, the putty composition comprising:
an acrylate-functional resin;
a filler composition comprising:
calcium carbonate particles; and
glidant particles selected from talc, magnesium stearate, silicon dioxide, starch, and a combination of two or more thereof;
wherein the calcium carbonate particles and the glidant particles are present in a weight ratio ranging from about 4:1 to about 1:1; and
(c) exposing the cellulosic substrate to a radiation source.

11. The method according to claim 10, wherein the putty composition has a viscosity ranging from about 100,000 cP to about 400,000 cP at about 25° C.

12. The method according to claim 10, wherein the cellulosic substrate is heated to a temperature ranging from about 35° C. to about 70° C. prior to step (b).

13. The method according to claim 10, wherein the radiation source comprises a UV lamp having a total UVA output of greater than about 300 mJ/cm² and a UVA peak irradiance greater than about 200 mW/cm².

14. The method of claim 15, wherein the depression has at a maximum depth of about 100 mil as measured from the top surface cellulosic substrate in a direction extending toward the bottom surface.

15. The method of claim 15, wherein the cellulosic substrate passes under the radiation source in step (c) at a line speed of at least 33 feet per minute.

16. A putty composition comprising:
an initiator component comprising a thermal initiator and a photo initiator;
an acrylate-functional resin; and
a filler composition comprising:
calcium carbonate particles; and
glidant particles;
wherein the calcium carbonate particles and the glidant particles are present in a weight ratio ranging from about 4:1 to about 1:1.

17. The putty composition of claim 16, wherein the putty-composition of troughable and has a viscosity ranging from about 100,000 cP to about 400,000 cP at about 25° C.

18. The putty composition according to claim 16, wherein the filler composition is present in an amount ranging from about 25 wt. % to about 75 wt. % based on the total weight of the putty composition.

19. The putty composition according to claim 16, wherein the glidant particles are selected from the group consisting of talc, magnesium stearate, silicon dioxide, starch, and a combination of two or more thereof.

20. The putty composition according to claim 16, wherein the calcium carbonate and the glidant particles are present in a weight ratio ranging from about 2:1 to about 1:1.
